(19) United States
(12) Patent Application Publication
(10) Pub. No.: US 2011/0052472 A1
(43) Pub. Date: Mar. 3, 2011

(54) Process for the Preparation of an Yttrium and Rare Earth Mixed Oxide

(75) Inventor: Xinming Wan, Shanghai (CN)

(73) Assignee: RHODIA CHINA CO., LTD., SHANGHAI (CN)

(21) Appl. No.: 12/670,223

(22) PCT Filed: Jul. 18, 2008
(86) PCT No.: PCT/CN08/01341

§ 371 Date: Nov. 17, 2010

(30) Foreign Application Priority Data
Jul. 23, 2007 (CN) 200710149449.4

(51) Int. Cl. C01F 17/00

(52) U.S. Cl. 423/263

(57) ABSTRACT

The process for the preparation of an yttrium and at least one rare earth mixed oxide comprises the following steps: a. mixing a precursor of the yttrium and at least one rare earth mixed oxide with a flux comprising a barium halide and a boron compound; b. calcining the mixture of step a to obtain said mixed oxide. This mixed oxide may be used as a phosphor in the manufacture of coloured fluorescent lamps, cathode ray tubes and plasma display panels.

The present invention concerns a process for the preparation of an yttrium and at least one rare earth mixed oxide.

Yttrium oxide finds applications in such field as ceramics and electronics. More precisely, europium activated yttrium oxide (YOX) is a red emitting material under UV or cathode ray excitation and, thus, it is used in the manufacture of coloured fluorescent lamps, cathode ray tubes (CRT) and plasma display panels (PDP).

Usually, YOX phosphor synthesis is performed by ceramic techniques, i.e., the direct calcination of Y₂O₃ and Eu₂O₃ mixtures. The Y₂O₃ and Eu₂O₃ oxides are obtained by a first calcination of precursors such as oxalates, which are previously prepared by sol-gel method or homogeneous precipitation. By a second calcination of the oxides in the presence of a flux, the YOX phosphor is obtained in the form of blocks which are very hard. It is then necessary to crush them by jaw crusher and rolling crusher, and then disperse the agglomeration by ball milling. The crushing and milling processes are known to be harmful for the brightness of the phosphor which is obtained. Moreover, this process necessitates two calcinations steps, which is costly and not convenient.

Thus, there is a need for a process for the preparation of YOX which is less costly, possibly with reduced calcination time and which would no more comprise milling steps.

The main object of the invention is the provision of such a process.

Thus, the process of the invention for the preparation of an yttrium and at least one rare earth mixed oxide comprises the following steps:
(a) mixing a precursor of the yttrium and at least one rare earth mixed oxide with a flux comprising a barium halide and a boron compound;
(b) calcining the mixture of step (a) to obtain said mixed oxide.

In the prior art, people usually calcinate the precursor into oxide firstly, then calcinate the obtained oxide with flux for the second time to produce finished oxide phosphor. The process of the invention comprises one calcination step only, calcinating precursor into oxide phosphor directly. The decrease of the calcination time is benefit to the convenience of the process of preparation of the oxide and is also cost saving. Moreover, crushing and milling steps are no more necessary, which is also cost saving and favourable to the luminescent properties of the oxide. Indeed blocks obtained after calcination in the process of the invention are very soft. As it is well known, crushing and milling steps generally damage the crystalline particles and bring easily exotic impurities into said particles. The omitted steps are very favourable to the luminescent properties of the oxide and also helpful for cost saving.

Other characteristics, details and advantages of the invention will become even more fully apparent on reading the description which will follow and the non-limiting example intended to illustrate it.

The term “rare earth” is understood to mean the elements of the group consisting of the elements of the Periodic Table with an atomic number of between 57 and 71 inclusive.

The Periodic Table of the Elements to which reference is made is that published in the supplement to the Bulletin de la Société Chimique de France, No. 1 (January 1966).

The process of the invention concerns the preparation of any mixed oxide of yttrium and of at least another rare earth corresponding generally to formula (1) (Y₁₋ₓREₓ)₂O₃, RE being one or more rare earths. In a manner which is known per se, the rare earth element is used as a dopant in combination with yttrium oxide in order to give to it luminescent properties. It must be noted here and for the rest of the description that the terms “rare earth” or “rare earth element” in the singular corresponds not only to the embodiment wherein one rare earth only is present in the mixed oxide but also to the embodiment wherein the mixed oxide comprises several rare earth in combination.

The rare earth may be more particularly europium or gadolinium. Still more particularly, the oxide may comprise as rare earths europium in combination with lanthanum and/or samarium.

In formula (1) x is a number which may vary in a large range corresponding to the quantity of rare earth sufficient to obtain satisfying luminescent properties. More particularly x may be comprised between 0.02 and 0.3, the values at the limits being included. For (Y₁₋ₓEuₓ)₂O₃, x may more preferably vary between 0.02 to 0.15.

The first step of the process of the invention, step (a), comprises mixing a precursor of the yttrium and at least one rare earth mixed oxide with a flux. It must be noted here and for the rest of the description that the term “precursor” may relate to one sole compound comprising both yttrium and the rare earth elements or to two or more precursors, that is a precursor of yttrium oxide and a precursor of the rare earth oxide or still a precursor of each rare earth oxide.

These precursors, which are compounds which by thermal decomposition lead to the production of oxides, are well known in the art. These precursors may be yttrium hydroxide and rare earth hydroxides such as Y(OH)₃ or Eu(OH)₃ for instance, or mixed hydroxides such as (Y,Eu)(OH)₃, yttrium carbonate, rare earth carbonates or yttrium rare earth mixed carbonates, or yttrium hydroxycarbonate, rare earth hydroxycarbonates or yttrium rare earth mixed hydroxycarbonates. However, preferred precursors are yttrium oxalate and rare earth oxalates and mixed oxalates such as for example (Y,Eu)₂(C₂O₄)₃.

Ammonium rare earth double oxalates or ammonium yttrium double oxalate may also be used, such as (Y,Eu)NH₄(C₂O₄)₂. Also, alkaline rare earth double oxalates or alkaline yttrium double oxalates, such as (Y,Eu)OHC₂O₄ may be used.

These precursors may be prepared by precipitation or sol-gel processes.

In step (a) of the process of the invention, the precursor is mixed with a flux which comprises a barium halide and a boron compound.

More particularly the barium halide may be a barium fluoride or barium chloride. Barium chloride is preferred.

For boron compound, boron oxide may be used but, preferably, boric acid H₃BO₃ is used. The presence of a boron compound in the flux increases the luminescent properties of the mixed oxide which is obtained.

According to preferred embodiments of the invention specific quantities of flux are used. The quantities which are mentioned here below corresponds to the weight percentage of the ratio quantity of barium halide/quantity of precursor or of the ratio quantity of boron compound/quantity of precursor.

Thus, concerning the barium halide, the content of this compound when mixing the flux and the precursor is preferably at least 0.5 wt %. With such a ratio, the blocks which are obtained at the end of step (b) are soft and can be crushed very easily. The upper limit is not critical and corresponds to a value beyond which there is no technical/industrial interest to run the process. A reasonable but not limitative upper limit may be 10 w %.

Concerning the boron compound, the content of this compound when mixing the flux and the precursor is at most 0.5 wt %, preferably at most 0.3 w %. A content higher than 0.5 wt % may lead to the formation of YBO₃ which may be detrimental to the luminescent properties of the YOX.

Other fluxes may be used in addition to the boron and barium compounds such as lithium or ammonium fluoride, lithium, sodium, potassium or ammonium chloride, ammonium phosphates, borax Na₂B₄O₇.

It is preferable to use water soluble flux when the total content of the flux is at least 1% because, in such a case, the elimination of the flux at the end of step (b) is easier.

The second step of the process of the invention is calcination step (b).

This calcination is made at a temperature and for a duration which are sufficient to decompose the precursor and to obtain the mixed oxide. Generally this temperature is at least 1200° C., more particularly at least 1300° C. and may be comprised between 1200° C. and 1500° C. The duration of the calcination may be comprised, for example, between 1 hour and 5 hours and it is the shorter the higher the calcination temperature.

Generally the calcination is made in air.

The product which is obtained at the end of step (b) is very soft and can be crushed by hand.

The process of the invention enables to obtain directly at the end of step (b) the mixed oxide. However, according to a particular embodiment of the invention, it is possible to carry out one additional step by dispersing the product obtained at the end of step (b) into water and by stirring it. Water may be de-ioned. The stirring may be made in hot water that is at a temperature of about 80° C.

After stirring, the product may be sieved, possibly washed with water and dried at a temperature which may be comprised between 100° C.-120° C. for instance. This additional step enables to eliminate the flux.

The crushing and milling steps of the prior art processes are not necessary in the process of the invention. The phosphor which is obtained by the process of the invention presents properties with respect to brightness, emission spectrum, colour coordination which are quite comparable to the properties of the products obtained by the prior art processes. Thus, the mixed oxide which is obtained by the process of the invention may be used as a phosphor for instance in the manufacture of coloured fluorescent lamps, cathode ray tubes (CRT) and plasma display panels (PDP).

Some examples will now be given.

### EXAMPLE 1

A powder of 100 g yttrium europium oxalate (Y_{0.934},Eu_{0.066})₂(C₂O₄)₃ is used as precursor. 3 g BaCl₂ and 0.2 g H₃BO₃ are added to the precursor as flux. After rotating for more than 3 hours, the mixture is calcinated at 1350° C. for 2 hours in air (un-closed system). The as-prepared material is very soft and can be squeezed into powder by hand. The powder is stirred in de-ioned water at 80° C. to remove the flux and disperse the agglomeration. Then the slurry is sieved by 400 meshes sieve and washed by hot de-ioned water. After being filtrated, the sedimentation slurry is dried at 120° C. and the YOX red phosphor is obtained.

Compared with a high quality commercial product, the brightness for the obtained YOX phosphor is of 101%. The color coordinate measured by PMS-50 plus UV-VIS-Near IR Spectro photocolorimeter (Everfine, China) is x=0.650 and y=0.347, similar with commercial product. The particle size D₅₀ is also similar with commercial one, which is 6.5 μm measured by Malvern 2000 laser particle size analyzer. The chlorine ion (Cl⁻) content in the YOX phosphor is below 20 ppm. It must be noted that although high content of BaCl₂ (3%) was used, there is almost no Cl⁻ impurities left in the finished YOX phosphor which is interesting since chlorine ion (Cl⁻) is harmful for the phosphor application.

### EXAMPLE 2

A powder of 100 g yttrium europium oxalate (Y_{0.88},Eu_{0.12})₂(C₂O₄)₃ is used as precursor. 2 g BaCl₂ and 0.2 g H₃BO₃ are added to the precursor as flux. After rotating for more than 3 hours, the mixture is calcinated at 1350° C. for 2 hours in air (un-closed system). The as-prepared material is very soft and can be squeezed into powder by hand. The material is treated in the same way as in example 1 to obtain the YOX red phosphor.

### EXAMPLE 3

A powder of 100 g yttrium europium oxalate (Y_{0.934},Eu_{0.066})₂(C₂O₄)₃ is used as precursor. 2 g BaCl₂ and 0.1 g B₂O₃ are added to the precursor as flux. After rotating for more than 3 hours, the mixture is calcinated at 1400° C. for 2 hours in air (un-closed system). The as-prepared material is very soft and can be squeezed into powder by hand. The material is treated in the same way as in example 1 to obtain the YOX red phosphor.

What is claimed is:

1. A process for the preparation of an yttrium and at least one rare earth mixed oxide which comprises the following steps:
(a) mixing a precursor of the yttrium and at least one rare earth mixed oxide with a flux comprising a barium halide and a boron compound;
(b) calcining the mixture of step (a) to obtain said mixed oxide.

2. The process according to claim 1, wherein said precursor is an yttrium and rare earth oxalate.

3. The process according claim 1, wherein said boron compound is H₃B0₃.

4. The process according claim 1, wherein said barium halide is barium chloride.

5. The process according claim 1, wherein said rare earth is gadolinium or europium.

6. The process according claim 1, wherein the content of barium halide when mixing the flux and the precursor is at least 0.5 wt %.

7. The process according claim 1, wherein the content of boron compound when mixing the flux and the precursor is at most 0.5 wt %, preferably at most 0.3 wt %.

8. The process according claim 1, wherein the mixed oxide obtained after step (b) is stirred in water, sieved and dried.
